(19) United States
(12) Patent Application Publication
(10) Pub. No.: US 2009/0140933 A1
(43) Pub. Date: Jun. 4, 2009

(54) RADIO APPARATUS AND ANTENNA DEVICE INCLUDING MAGNETIC MATERIAL FOR ISOLATION

(75) Inventors: Naoto Ito, Tokyo (JP); Akihiro Tsujimura, Tokyo (JP); Takashi Amano, Saitama-ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/185,376

(22) Filed: Aug. 4, 2008

(30) Foreign Application Priority Data
Nov. 29, 2007 (JP) 2007-309452

(51) Int. Cl. H01Q 1/24; H01Q 1/00

(52) U.S. Cl. 343/702; 343/787

(57) ABSTRACT

A radio apparatus having a printed board, an antenna element and an isolating member is provided. The antenna element is connected to the printed board. The isolating member is formed by layering a magnetic layer made of magnetic material and a dielectric layer made of dielectric material. The isolating member is folded and arranged in such a way that the magnetic layer is placed no less than twice between the printed board and the antenna element.

### CROSS REFERENCE TO RELATED APPLICATIONS

This application is based upon and claims the benefit of priority from the prior Japanese Patent Application No. 2007-309452 filed on Nov. 29, 2007; the entire contents of which are incorporated herein by reference.

### BACKGROUND OF THE INVENTION

1. Field of the Invention

The present invention relates to a radio apparatus and an antenna device, and in particular to an antenna device including magnetic material for isolation and a radio apparatus having the antenna device.

2. Description of the Related Art

A portable radio apparatus such as a mobile phone often has a limited mounting space, and thus may suffer from a problem of interference caused by electromagnetic or capacitive couplings among an antenna and each of portions of an electrical circuit of the radio apparatus. In particular, the antenna may often face a problem of degraded radiation efficiency.

To the above problems, possible solutions using magnetic material have been proposed. For instance, a conventional portable radio apparatus is disclosed in Japanese Patent Publication (Toroku), No. 3713476.

More specifically, the radio apparatus disclosed in JP 3713476 includes a built-in L-shaped antenna and a magnetic material plate provided on a circuit board which faces the L-shaped antenna. The radio apparatus of JP 3713476 has an effect that magnetic field strength on a surface of a ground conductor layer of the circuit board and induced currents may be reduced so that directivity of the antenna may become stable.

Another example of the possible solutions is a conventional antenna device having sheet-like material that includes a magnetic material layer between an electric field type antenna element and conductive material disclosed in Japanese Patent Publication of Unexamined Applications (Kokai), No. 2007-124638.

According to JP 2007-124638, the antenna device may prevent input impedance from decreasing so as to improve radiation efficiency.

Yet another example of the possible solutions is an antenna device having magnetic material between an antenna element including a feed portion and a printed board on which a metallic layer has been formed to provide the antenna element with a ground voltage level, disclosed in Japanese Patent Publication of Unexamined Applications (Kokai), No. 2007-89232.

The magnetic material of JP 2007-89232 includes plural magnetic material plates of a nano-granular structure in which nanoparticles of strong magnetic properties are dispersed. The magnetic material of JP 2007-89232 is structured in such a way that the magnetic material plates and dielectric layers are alternately layered parallel to each other.

Having the magnetic material plate between an antenna element of the built-in antenna and the ground conductor layer, as described above, the radio apparatus of JP 3713476 may reduce an effect of an unbalanced current induced in the ground conductor. The sheet-like material of JP 2007-124638 may be used for the above magnetic material plate.

The sheet-like material of JP 2007-124638 requires, however, a high value of magnetic permeability such as 50 for a real part of complex relative magnetic permeability μ′, and requires a thick membrane such as a magnetic material layer being 0.5 millimeters (mm) thick, as described in paragraphs 0160-0161 of JP 2007-124638.

The antenna device of JP 2007-89232 of the JP application filed by the assignee of the present application forms the magnetic material by having the plural magnetic material plates and the dielectric layers alternately layered parallel to each other. The antenna device of JP 2007-89232 using magnetic material plates of small thickness which may be simply and inexpensively made may thus achieve an impedance characteristic which is equivalent to a characteristic achieved by using a thick, expensive and single magnetic material plate.

### SUMMARY OF THE INVENTION

Accordingly, an object of the present invention is to further improve the invention of JP 2007-89232, and more specifically to form an isolating member including a magnetic material layer in a simpler manner so as to simplify a production process of radio apparatus.

To achieve the above object, according to one aspect of the present invention, a radio apparatus having a printed board, an antenna element and an isolating member is provided. The antenna element is connected to the printed board. The isolating member is formed by layering a magnetic layer made of magnetic material and a dielectric layer made of dielectric material. The isolating member is folded and arranged in such a way that the magnetic layer is placed no less than twice between the printed board and the antenna element.

### BRIEF DESCRIPTION OF THE DRAWINGS

FIG. 1 is a perspective view of a main portion of a radio apparatus of a first embodiment of the present invention showing a configuration of an antenna device included in the radio apparatus.

FIG. 2 is a cross section of the antenna device and a printed board of the first embodiment showing an example of an isolating member being U-shaped.

FIG. 3 is a cross section of the isolating member of the first embodiment not being folded.

FIG. 4 is a cross section of the antenna device and the printed board of the first embodiment showing an example of the isolating member being folded like a FIG. “2”.

FIG. 5 is a cross section of the antenna device and the printed board of the first embodiment showing an example of the isolating member being folded like a FIG. “6”.

FIG. 6 is a cross section of the antenna device and the printed board of the first embodiment showing an example of a pair of the isolating members being U-shaped.

FIG. 7 is a cross section of the antenna device and the printed board of the first embodiment showing an example of a pair of the isolating members being folded like the FIG. “2” and like the FIG. “6”.

FIG. 8 is a cross section of the antenna device and the printed board of the first embodiment adapted for a configuration of a simulation model to prove an effect of the first embodiment.

FIG. 9 is a cross section of a modification of the antenna device and the printed board of the first embodiment adapted for a configuration of another simulation model to be compared with the simulation model of FIG. 8.

FIG. 10 is a graph of frequency characteristics of radiation efficiency of the simulation models of the first embodiment shown in FIG. 8 and FIG. 9 estimated by simulation.

FIG. 11 is a perspective view of a main portion of a radio apparatus of a second embodiment of the present invention showing a configuration of an antenna device included in the radio apparatus.

FIG. 12 is a cross section of the antenna device and a printed board of the second embodiment.

FIG. 13 is a perspective view of the antenna device and the printed board of the second embodiment adapted for a configuration of a simulation model to prove an effect of the second embodiment.

FIG. 14 is a perspective view of the antenna device and the printed board of the second embodiment adapted for a configuration of another simulation model to be compared with the simulation model of FIG. 13.

FIG. 15 is a graph of radiation efficiency of the simulation models of FIGS. 13 and 14 against one of dimensions of a magnetic layer of an isolating member at a resonant frequency estimated by simulation.

### DETAILED DESCRIPTION OF THE INVENTION

Hereinafter, embodiments of the present invention will be described in detail. In following descriptions, terms such as upper, lower, left, right, horizontal or vertical used while referring to a drawing shall be interpreted on a page of the drawing unless otherwise noted. Besides, a same reference numeral given in no less than two drawings shall represent a same member or a same portion.

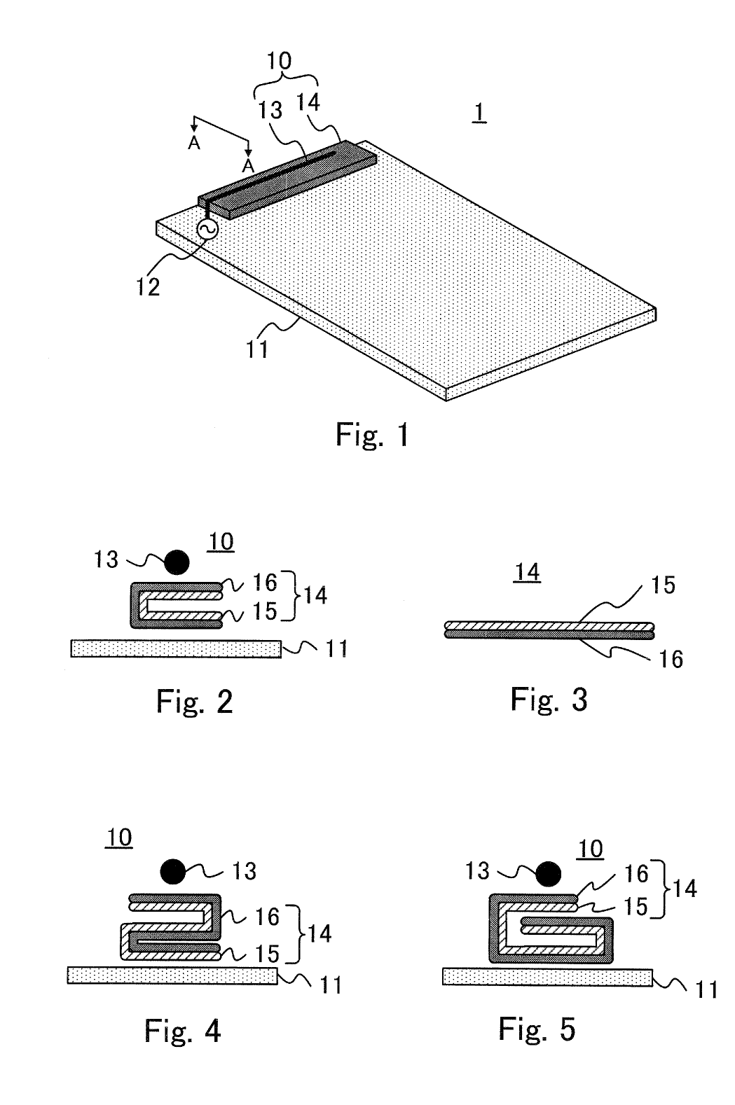

A first embodiment of the present invention will be described with reference to FIGS. 1-10. FIG. 1 is a perspective view of a main portion of a radio apparatus 1 of the first embodiment showing a configuration of an antenna device 10 included in the radio apparatus 1.

As shown in FIG. 1, the radio apparatus 1 has a printed board 11, an antenna element 13 connected to a feed portion 12 provided in the printed board 11 and an isolating member 14. Among the above portions, the antenna element 13 and the isolating member 14 form the antenna device 10.

FIG. 2 is a cross section of the antenna device 10 and the printed board 11 along a line with arrows “A-A” shown in FIG. 1, showing a first example of a shape and an arrangement of the isolating member 14. As shown in FIG. 2, the isolating member 14 is arranged between the printed board 11 and the antenna element 13.

As shown in FIG. 3, the isolating member 14 is formed by layering a magnetic layer 15 made of magnetic material and a dielectric layer 16 made of dielectric material. The isolating member 14 is shaped into a plane by layering a dielectric material base (the dielectric layer 16) which is flexible like polyimide and a magnetic material sheet (the magnetic layer 15), and then folded to have a U-shaped cross section (no matter how the U-shape is tilted) as shown in FIG. 2. The isolating member 14 is arranged in such a way that the magnetic layer 15 is placed twice between the printed board 11 and the antenna element 13.

FIG. 4 is a cross section similar to FIG. 2 showing a second example of the shape and the arrangement of the isolating member 14. In this example, the isolating member is folded to have a cross section like a FIG. “2”. The isolating member 14 is arranged in such a way that the magnetic layer 15 is placed thrice between the printed board 11 and the antenna element 13.

FIG. 5 is a cross section similar to FIG. 2 showing a third example of the shape and the arrangement of the isolating member 14. In this example, the isolating member 14 is folded to have a cross section like a FIG. “6”. The isolating member 14 is arranged in such a way that the magnetic layer 15 is placed thrice between the printed board 11 and the antenna element 13.

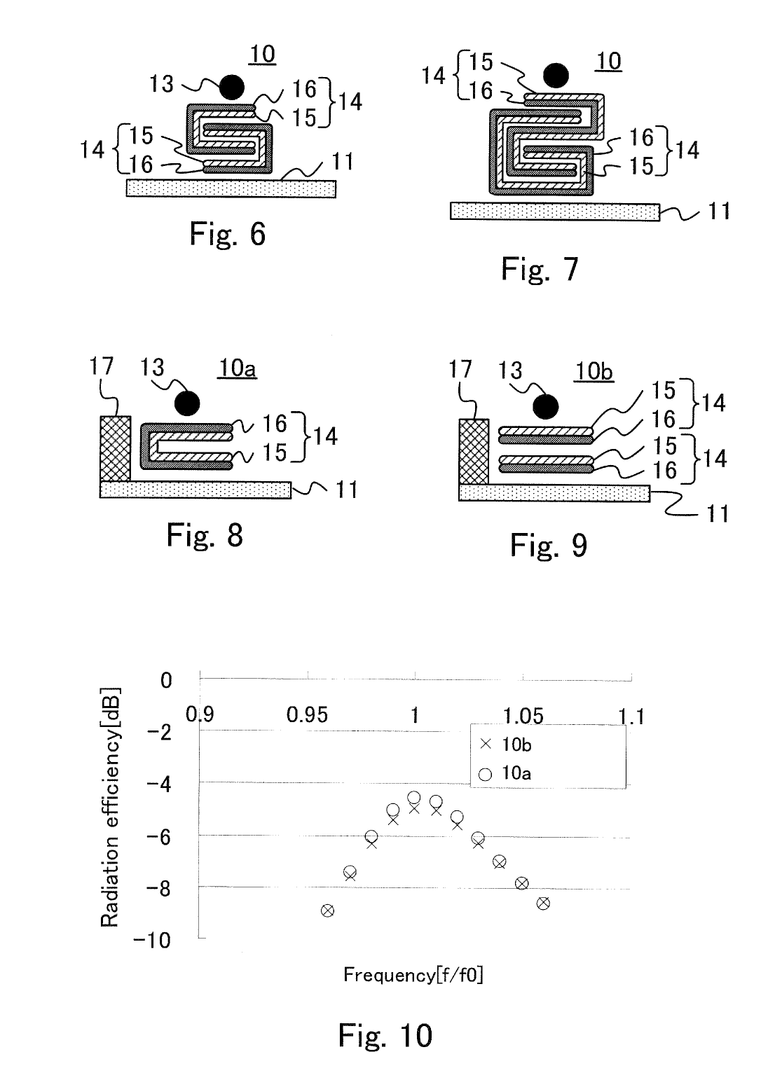

FIG. 6 is a cross section similar to FIG. 2 showing a pair of isolating members, each of which is the isolating member 14 folded to be U-shaped as shown in FIG. 2, arranged between the printed board 11 and the antenna element 13. The pair of the isolating members is arranged in such a way that the magnetic layer 15 is placed four times between the printed board 11 and the antenna element 13.

FIG. 7 is a cross section similar to FIG. 2 showing another pair of isolating members. One of the pair is the isolating member 14 folded like the FIG. “2” as shown in FIG. 4, and another one of the pair is the isolating member 14 folded like the FIG. “6” as shown in FIG. 5, both arranged between the printed board 11 and the antenna element 13. The pair of the isolating members is arranged in such a way that the magnetic layer 15 is placed six times between the printed board 11 and the antenna element 13.

As shown in FIG. 2 and FIGS. 4-7, the isolating member 14 is arranged in such a way that the magnetic layer 15 is placed no less than twice between the printed board 11 and the antenna element 13 so as to have a magnetic material layer equivalently thick even in a case where the isolating member 14 which is simply formed as shown in FIG. 3 is used. Consequently, the radio apparatus 1 may raise an effect of isolation between a ground conductor of the printed board 11 and the antenna element 13 so as to improve an impedance characteristic and radiation efficiency of the antenna device 10.

As the antenna device 10 is formed by folding the isolating member 14 and arranging the folded isolating member 14 between the printed board 11 and the antenna element 13, the radio apparatus 1 may allow a simplified production process in comparison with a method of forming an isolating member by layering plural magnetic material layers and plural dielectric material layers alternately.

As a portion of the magnetic layer 15 is arranged perpendicular to a face of the printed board 11 as shown in FIG. 2 and FIGS. 4-7, the isolating member 14 may contribute to isolation between the antenna element 13 and a conductive material which may be arranged perpendicular to the face of the printed board 11.

An effect of the first embodiment will be described with reference to FIGS. 8-10. FIG. 8 is a cross section similar to FIG. 2 adapted for a configuration of a simulation model (called an antenna device 10a) to prove the effect of the first embodiment. The simulation model has the isolating member 14 folded to have a U-shaped cross section as shown in FIG. 2, and a conductive material 17 directed perpendicular to the face of the printed board 11. Each of other portions shown in FIG. 8 is given a same reference numeral as the corresponding one shown in the previous drawings such as FIG. 2.

FIG. 9 is a cross section similar to FIG. 2 adapted for a configuration of another simulation model (called an antenna device 10b) to be compared with the simulation model of FIG. 8. The antenna device 10b has an isolating member formed by layering plural magnetic material layers and plural dielectric material layers alternately. For convenience of explanation, each of portions shown in FIG. 9 is given a same reference numeral as the corresponding one shown in FIG. 8.

FIG. 10 is a graph of frequency characteristics of radiation efficiency of the antenna devices 10a and 10b estimated by simulation. The graph has a horizontal axis representing frequency values normalized by a resonant frequency of the antenna element 13, which is no-dimensional. The graph has a vertical axis representing radiation efficiency in decibel (dB). Circular and X-like plots of the graph represent the characteristics of the antenna devices 10a and 10b, respectively.

As shown in FIG. 10, the antenna device 10a shows somewhat better radiation efficiency than the antenna device 10b at and around the resonant frequency of the antenna element 13. Why such improvement has been achieved is that the antenna device 10a has not only an isolation effect between the printed board 11 and the antenna element 13 which is equivalent to an effect achieved by layering plural magnetic layers and plural dielectric layers, but also an isolation effect between the antenna element 13 and the conductive material 17.

According to the first embodiment of the present invention described above, the antenna device having the isolating member formed by layering the magnetic layer and the dielectric layer, folded and arranged between the printed board and the antenna element, may achieve radiation efficiency which is no worse than radiation efficiency achieved by layering plural magnetic layers and plural dielectric layers alternately.

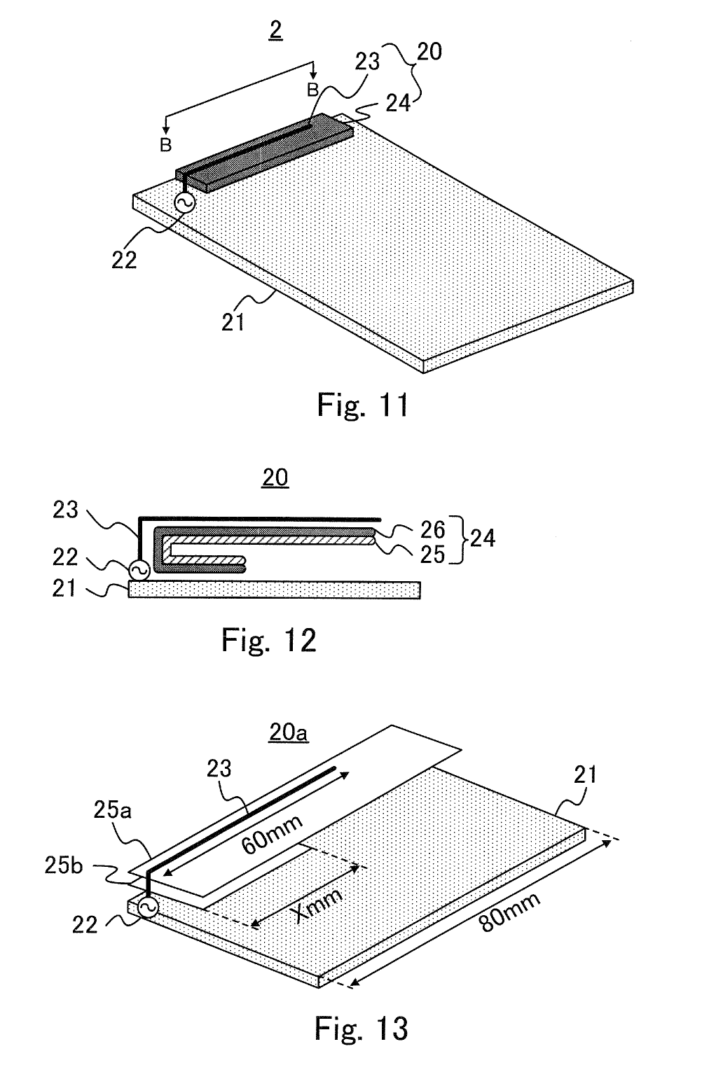

A second embodiment of the present invention will be described with reference to FIGS. 11-15. FIG. 11 is a perspective view of a main portion of a radio apparatus 2 of the second embodiment showing a configuration of an antenna device 20 included in the radio apparatus 2.

As shown in FIG. 11, the radio apparatus 2 has a printed board 21, an antenna element 23 connected to a feed portion 22 provided in the printed board 21 and an isolating member 24. Among the above portions, the antenna element 23 and the isolating member 24 form the antenna device 20.

FIG. 12 is a cross section of the antenna device 20 and the printed board 21 along a line with arrows “B-B” shown in FIG. 11, showing an example of a shape and an arrangement of the isolating member 24. As shown in FIG. 12, the isolating member 24 is arranged between the printed board 21 and the antenna element 23. The isolating member 24 is formed by layering a magnetic layer 25 made of magnetic material and a dielectric layer 26 made of dielectric material, like the isolating member 14 of the first embodiment.

If the antenna element 23 is fed through the feed portion 22, an antenna current of a relatively great amplitude is distributed on a portion of the antenna element 23 near the feed portion 22. Without the isolating member 24, thus, portions of the antenna element 23 and a ground conductor of the printed board 21 most strongly coupled magnetically are a portion of the antenna element 23 parallel to the printed board 21 and nearest the feed portion 22 (called a root portion) and a portion of the printed board 21 facing the root portion of the antenna element 23.

On the other hand, an antenna current distributed on a portion of the antenna element 23 near an end (called an end portion) has such a relatively small amplitude that the end portion of the antenna element 23 is less strongly coupled magnetically to the printed board 21.

As shown in FIG. 12, the isolating member 24 is arranged in such a way that the magnetic layer 25 is placed more times near the root portion of the antenna element 23 where the current of the relatively great amplitude is distributed (i.e., where the antenna element 23 and the ground conductor of the printed board 21 are most strongly coupled magnetically) while being fed than near other portions of the antenna element 23.

By arranging the isolating member 24 as described above, the radio apparatus 2 may save the materials of the magnetic layer 25 and the dielectric layer 26 without disturbing much of the isolation effect between the antenna element 23 and the printed board 21.

An effect of the second embodiment will be described with reference to FIGS. 13-15. FIG. 13 is a perspective view of the antenna device 20 adapted for a configuration of a simulation model (called an antenna device 20a) to prove the effect of the second embodiment. The simulation model includes a pair of an upper magnetic layer 25a and a lower magnetic layer 25b corresponding to the magnetic layer 25 of the isolating member 24 shown in FIG. 12. Each of other portions shown in FIG. 13 is given a same reference numeral as the corresponding one shown in FIG. 11.

As shown in FIG. 13, the antenna element 23 has a length of 60 millimeters (mm) in a longer direction. The length of 60 mm is associated with a resonant frequency based on a wavelength shortening effect of magnetic and dielectric base materials. The printed board 21, the magnetic layer 25a and the magnetic layer 25b are 80 mm (nearly a quarter wavelength), 80 mm and×mm long, respectively, in the longer direction of the antenna element 23, where X is a variable represented by a horizontal axis of FIG. 15 to be explained later.

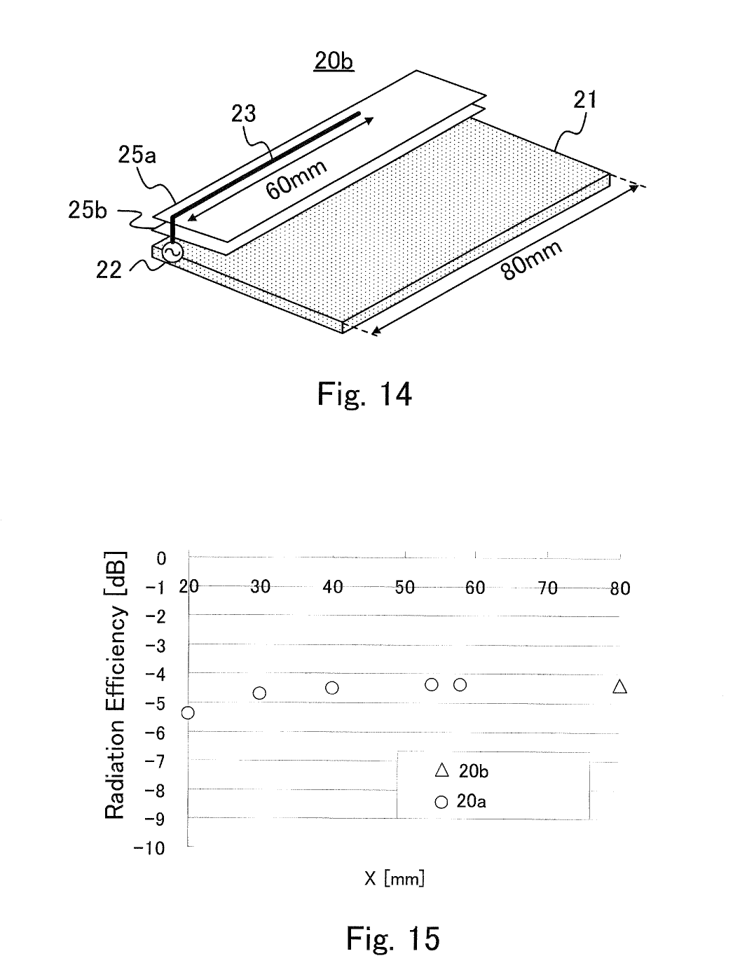

FIG. 14 is a perspective view of the antenna device 20 adapted for a configuration of another simulation model (called an antenna device 20b) to be compared with the simulation model of FIG. 13. In the configuration of the antenna device 20b, the upper magnetic layer 25a and the lower magnetic layer 25b are equally 80 mm long in the longer direction of the antenna element 23. Each of portions shown in FIG. 14 is given a same reference numeral as the corresponding one shown in FIG. 13.

FIG. 15 is a graph of radiation efficiency of the antenna devices 20a and 20b against the variable X at a resonant frequency f0 estimated by simulation. The graph has a horizontal axis representing the variable X in mm, and a vertical axis representing the radiation efficiency in dB. Circular and triangular plots of the graph represent the characteristics of the antenna devices 20a (20≦X≦60) and 20b (X=80), respectively.

As shown in FIG. 15, if the length of the magnetic layer 25b decreases from 80 mm at which the magnetic layer 25b may cover a whole length of the printed board 21, but remains no less than one third as long as the antenna element 23 (i.e. no less than 20 mm) in the longer direction of the antenna element 23, degradation of the radiation efficiency remains no greater than one dB which does not make a big difference.

According to the second embodiment of the present invention described above, the radio apparatus may save the materials of the isolating member without disturbing much of the isolation effect by arranging the isolating member in such a way that the magnetic layer may be placed a greater number of times between the printed board and the portion of the antenna element where the antenna current of a relatively great amplitude is distributed.

In the above description of the embodiments, the configurations, shapes, dimensions, connections or positional relations of the antenna devices, the materials such as the isolating members, the printed boards, etc. are considered as exemplary only, and thus may be variously modified within the scope of the present invention.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A radio apparatus, comprising:
a printed board;
an antenna element connected to the printed board; and
an isolating member formed by layering a magnetic layer made of magnetic material and a dielectric layer made of dielectric material,
the isolating member folded and arranged in such a way that the magnetic layer is placed no less than twice between the printed board and the antenna element.

2. The radio apparatus of claim 1, wherein the isolating member is shaped into a plane by layering a flexible dielectric material base and a magnetic material sheet, the isolating member then formed by being folded.

3. The radio apparatus of claim 1, further comprising an additional one of the isolating member arranged between the printed board and the antenna element.

4. The radio apparatus of claim 1, wherein the isolating member is arranged in such a way that the magnetic layer is placed more times near a first portion of the antenna element than near portions of the antenna element other than the first portion, the antenna element having a current of a relatively great amplitude distributed on the first portion while being fed.

5. An antenna device included in a radio apparatus, the radio apparatus including a printed board, comprising:
an antenna element connected to the printed board; and
an isolating member formed by layering a magnetic layer made of magnetic material and a dielectric layer made of dielectric material,
the isolating member folded and arranged in such a way that the magnetic layer is placed no less than twice between the printed board and the antenna element.

6. The antenna device of claim 5, wherein the isolating member is shaped into a plane by layering a flexible dielectric material base and a magnetic material sheet, the isolating member then formed by being folded.

7. The antenna device of claim 5, further comprising an additional one of the isolating member arranged between the printed board and the antenna element.

8. The antenna device of claim 5, wherein the isolating member is arranged in such a way that the magnetic layer is placed more times near a first portion of the antenna element than near portions of the antenna element other than the first portion, the antenna element having a current of a relatively great amplitude distributed on the first portion while being fed.

9. A method for making a radio apparatus including a printed board and an antenna element, comprising:
forming an isolating member by layering a magnetic layer made of magnetic material and a dielectric layer made of dielectric material, folding the isolating member; and
arranging the isolating member in such a way that the magnetic layer is placed no less than twice between the printed board and the antenna element.

10. The method of claim 9, wherein the isolating member is formed by being shaped into a plane by layering a flexible dielectric material base and a magnetic material sheet.

11. The method of claim 9, further comprising arranging an additional one of the isolating member between the printed board and the antenna element.

12. The method of claim 9, wherein the isolating member is arranged in such a way that the magnetic layer is placed more times near a first portion of the antenna element than near portions of the antenna element other than the first portion, the antenna element having a current of a relatively great amplitude distributed on the first portion while being fed.
